(19) United States
(12) Patent Application Publication
(10) Pub. No.: US 2025/0259808 A1
(43) Pub. Date: Aug. 14, 2025

(54) AIR INSULATED ISOLATION GAP COMPRESSIBLE DIAPHRAGM

(71) Applicant: S&C Electric Company, Chicago, IL (US)

(72) Inventors: Leo Caro, Chicago, IL (US); Nicholas Seng, Chicago, IL (US); Zachary Zezinka, Chicago, IL (US); Michael R. Maroney, Chicago, IL (US)

(73) Assignee: S&C Electric Company, Chicago, IL (US)

(21) Appl. No.: 19/038,056

(22) Filed: Jan. 27, 2025

Related U.S. Application Data
(60) Provisional application No. 63/552,706, filed on Feb. 13, 2024.

(51) Int. Cl. H01H 31/32; H01R 13/53

(52) U.S. Cl. CPC H01H 31/32; H01R 13/53

(57) ABSTRACT

A switch including an upper housing, a lower housing, a contact pin slidable between and within the upper and lower housings, an open chamber between the upper and lower housings and a viewing window surrounding the chamber. The contact pin is positioned in the chamber and is visible through the window when the switch is in the closed position and is positioned within the lower housing and not visible through the window when the switch is in the open position. The switch further includes an insulative plug coupled to the contact pin and being configured to provide electrical isolation between the contact pin and an upper contact when the switch is in the open position.

### CROSS-REFERENCE TO RELATED APPLICATION

This application claims the benefit of priority from the U.S. Provisional Application No. 63/552,706, filed on Feb. 13, 2024, the disclosure of which is hereby expressly incorporated herein by reference for all purposes.

### BACKGROUND

### Field

This disclosure relates generally to a switch including a dielectric plug providing increased dielectric strength between switch contacts when the switch is in an open position and, more particularly, to a switch including a compressible dielectric plug.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeder lines that carry the same current but are 120° apart in phase. Three-phase and/or single phase lateral lines are tapped off of the feeder that provide the medium voltage to various distribution transformers, where the voltage is stepped down to a low voltage and is provided to loads, such as homes, businesses, etc.

Power distribution networks of the type referred to above include switching devices, breakers, reclosers, interrupters, etc. that control the flow of power throughout the network. Some of these components are enclosed in external housings that are mounted on, for example, a concrete pad, or mounted underground, and are generally referred to herein as switchgear. Switchgear typically operate at medium voltage power and include switches to which cables are connected to route power in the power distribution network from, for example, certain power sources to certain loads. The number and type of switchgear are application specific to the particular power network.

Various switchgear designs allow the switches therein to be remotely controlled and/or allow a lineman to manually change the state of the switches. Sometimes these switches include a visible isolation gap that allows the lineman to visually determine whether the switch is open or closed as a safety feature. When the switch is open, a suitable insulating dielectric needs to be maintained between the switch contacts to prevent arcing therebetween. Air and other gases can operate as such a dielectric, but they have a limited dielectric strength. It is generally desirable to reduce the size of the switch, which often requires the use of specialized dielectric materials, such as a silicon fluid, having a greater dielectric strength than air or other gases. However, it is also desirable to reduce the complexity of the switch, which reduces the desire to use such specialized dielectric materials.

### SUMMARY

The following discussion discloses and describes a switch including a dielectric plug providing increased dielectric strength between switch contacts when the switch is in the open position. The switch includes an upper housing including an upper female contact, a lower housing including a lower female contact, and a cylindrical contact pin including an upper end and a lower end, where the contact pin is slidable between and within the upper and lower housings, and makes electrical contact with the upper and lower contacts when the switch is in a closed position and disengages the upper contact when the switch is in an open position. The switch also includes an open chamber between the upper and lower housings and a viewing window surrounding the chamber and being coupled to the upper and lower housings, where the contact pin is positioned in the chamber and is visible through the window when the switch is in the closed positioned and is positioned within the lower housing and not visible through the window when the switch is in the open position.

In one embodiment, the switch also includes an insulative rod extending through the insulative plug and the contact pin and protrudes from both of the upper and lower ends of the contact pin, where the insulative rod includes a plate coupled to an end of the insulative rod extending from the upper end of the contact pin, and where the plug is a compressible plug and is positioned between the upper end of the contact pin and the plate and the upper housing includes an interface. The switch also includes a stop ring positioned within the lower housing, where the drive rod extending through the stop ring. The drive rod is actuated to pull the insulative rod through the stop ring so that the contact pin disengages the upper contact and the contact pin is pulled into the lower housing and the lower end of the contact pin engages the stop ring which causes the insulative plug to axially compress between the plate and the first end of the contact pin and radially expand into the interface.

In another embodiment, the insulative plug is a rigid plug and includes a top plate and is in contact with the upper end of the contact pin when the switch is in the closed position, the upper housing includes a housing stop member, the upper contact includes a contact stop member and the drive rod is rigidly secured to the lower end of the contact pin. The switch further includes a return spring positioned between the housing stop member and the top plate of the plug, and a flexible diaphragm positioned within the upper housing and including a central bore, where the return spring is under compression and the contact pin extends through the central bore when the switch is in the closed position. The drive rod is actuated to pull the drive rod so that the contact pin disengages the upper contact and the contact pin is pulled into the lower housing, which causes the return spring to drive the insulative plug into the bore in the diaphragm and causes the top plate to contact the contact stop member.

Additional features of the disclosure will become apparent from the following description and appended claims, taken in conjunction with the accompanying drawings.

### BRIEF DESCRIPTION OF THE DRAWINGS

FIG. 1 is an isometric view of a pad mounted switchgear;

FIG. 2 is a cut-away, cross-sectional type view of a switch that can be used in the switchgear shown in FIG. 1 including a compressible insulative plug, where the switch is shown in the open position;

FIG. 3 is a cut-away, cross-sectional type view of the switch shown in FIG. 2 in the closed position;

FIG. 4 is a side view of a slidable switch assembly separated from the switch shown in FIG. 2 including a male contact pin and the compressible insulative plug shown in the open position;

FIG. 5 is a side view of the slidable switch assembly shown in FIG. 4 in the closed position;

FIG. 6 is a cut-away, cross-sectional type view of a switch that can be used in the switchgear shown in FIG. 1 including a compressible insulative diaphragm and a rigid insulative plug, where the switch is shown in the open position; and

FIG. 7 is a cut-away, cross-sectional type view of the switch shown in FIG. 6 in the closed position.

### DETAILED DESCRIPTION OF THE EMBODIMENTS

The following discussion of the embodiments of the disclosure directed to a switch including a compressible dielectric plug providing increased dielectric strength between switch contacts when the switch is in the open position is merely exemplary in nature, and is in no way intended to limit the invention or its applications or uses. For example, the switch described herein has particular application for use in switchgear. However, as will be appreciated by those skilled in the art, the switch will have other applications.

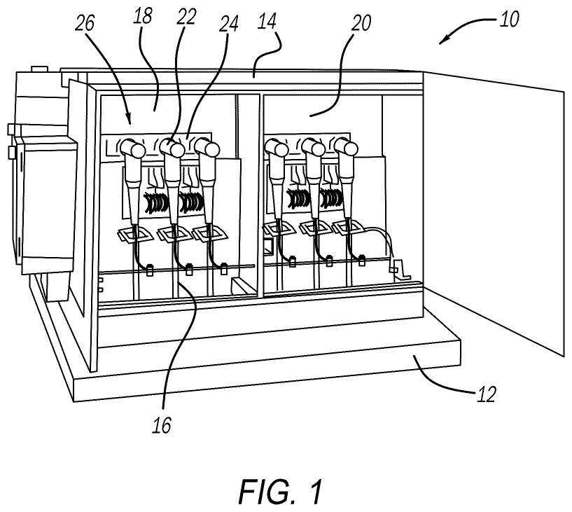

FIG. 1 is an isometric view of a known air-insulated elbow mounted switchgear 10 positioned on a concrete pad 12. For purposes of the discussion herein, the switchgear 10 is intended to represent any switchgear, pad mounted or otherwise, that includes any suitable configuration of components and devices configured in an outer housing 14 that provide switching and disconnecting of and between one or more electrical cables 16 coupled thereto that are part of an electrical distribution network. In this specific non-limiting example, six of the cables 16 are coupled to a front part of the switchgear 10 and six more of the cables (not shown) are coupled to a back part of the switchgear 10, where three of the cables 16 at the front and the back part are provided on one side 18 of the switchgear 10 and three of the cables 16 at the front and back part are provided on another side 20 of the switchgear 10. Each of the cables 16 is coupled to a T-body connector 22 that is electrically coupled to switches in the switchgear 10 at cable attachment points 24 at an upper location 26 on the switchgear 10. It is noted that the T-body connector 22, typically used for a 600 amp connector, is shown by way of a non-limiting example in that any suitable cable connector can be used, such as a 200 amp elbow connector.

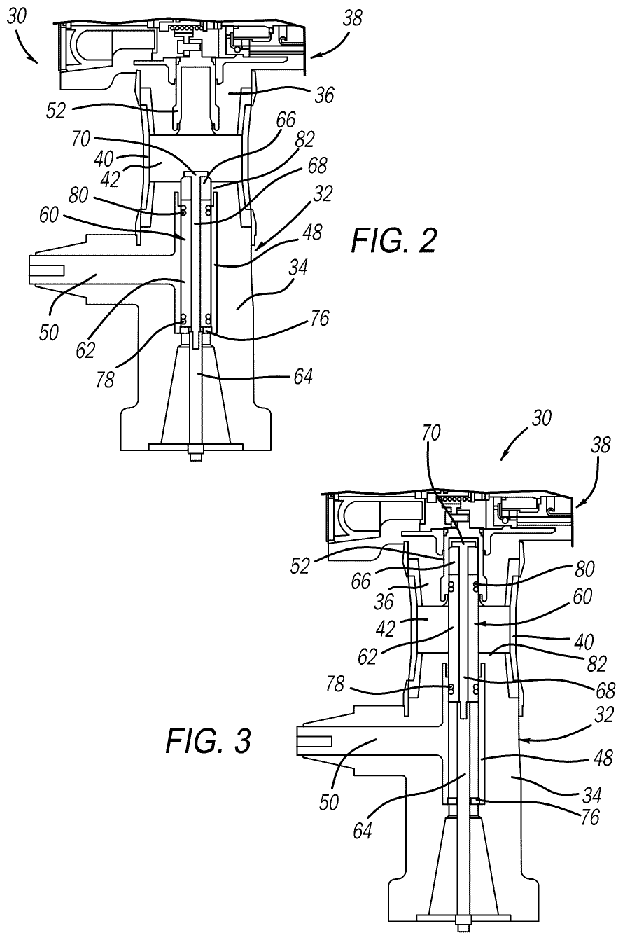

FIGS. 2 and 3 are cut-away, cross-sectional type views of an isolating pole unit or switch 30 that can be used in the switchgear 10, where the switch 30 is shown in an open position in FIG. 2 and in a closed position in FIG. 3. The switch 30 includes a body 32 having a lower housing 34, an upper housing 36 secured to switch elements 38, and a viewing window 40 open to a chamber 42 positioned between the lower housing 34 and the upper housing 36. A lower female contact 48 is positioned in the lower housing 34 and is electrically coupled to a connector 50 and an upper female contact 52 is positioned in the upper housing 36. A slidable switch assembly 60 is slidably positioned within the body 32 and includes a cylindrical male conductive contact pin 62, an insulating drive rod 64 coupled to a bottom end of the pin 62, a cylindrical compressible insulative plug 66 coupled to a top end of the pin 62 and an insulating compression rod 68 having a top plate 70 extending through the plug 66 and the pin 62 and into the rod 64, where the rod 68 is rigidly coupled to the rod 64. The plug 66 can be made of any insulative and compressible material, such as rubber, suitable for the purposes discussed herein. The bottom end of the contact pin 62 engages a stop ring 76 and the rod 68 extends through the ring 76 when the switch 30 is in the open position. Slidable contacts 78 are provided around the bottom end of the pin 62 and make contact with the lower female contact 48 and slidable contacts 80 are provided around the top end of the pin 62 and make contact with the upper female contact 50 when the switch 30 is in the closed position.

An interference fit is provided between an inner diameter of the insulative plug 66 and an outer diameter of the compression rod 68 to create a solid dielectric joint therebetween. A clearance fit is provided between the contact pin 62 and the compression rod 68 to allow for independent movement of the rod 68 within the pin 62 during the switch closing and opening operations. As will be discussed in further detail below, when the switch 30 opens, the insulative plug 66 is compressed between the top plate 70 and the top end of the pin 62 in an axially direction so that it expands in a radially direction and compresses against an interface 82 in the lower housing 34 to provide additional dielectric strength. This allows the chamber 42 to be filled with a suitable gas, such as air, and still provide enough dielectric integrity to prevent arcing between the contact pin 62 and the upper female contact 52 over a minimal gap therebetween.

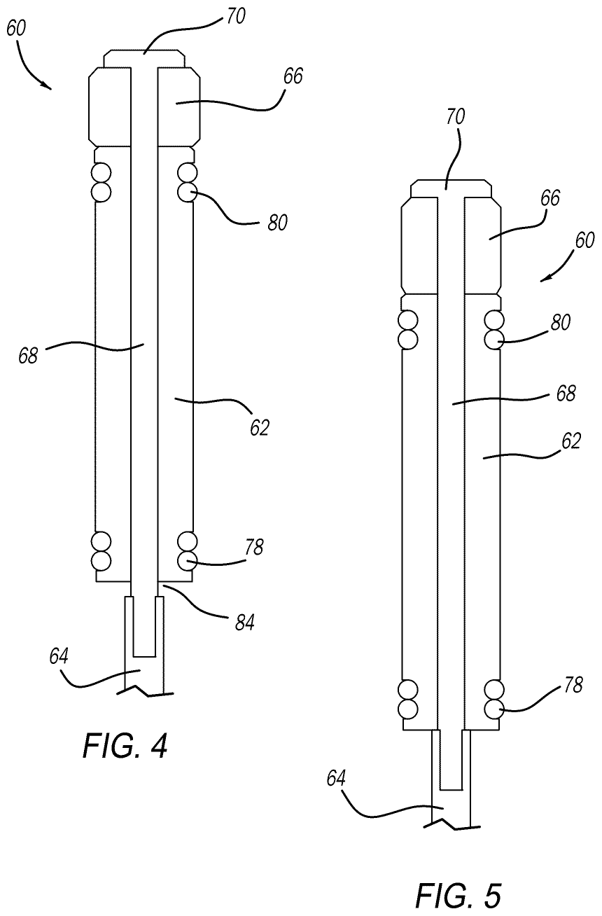

FIGS. 4 and 5 are side views of the slidable assembly 60 separated from the switch 30, where the assembly 60 is in the open position in FIG. 4 and is in the closed position in FIG. 5. The insulative plug 66 is shown compressed in FIG. 4 illustrating that the pin 62 and the rod 68 separate and a compression gap 84 is created between the bottom of the pin 62 and the top of the rod 68. The insulative plug 66 is not compressed in FIG. 5.

When the switch 30 is in the closed position, the male contact pin 62 contacts the upper and lower female contacts 52 and 48 and the uncompressed insulative plug 66 is resting between the top plate 70 of the insulated compression rod 68 and the male contact pin 62. The contact pin 62 is visible in the window 40 indicating that the switch 30 is closed. When the switch 30 is opened, an actuator (not shown) pulls the rod 64 downward and thus the rod 68 downward through the lower female contact 48 so that the contact pin 62 disengages the upper female contact 52. The contact pin 62 stops its downward movement when it contacts the stop ring 76 in the lower section of the lower female contact 48. The pin 62 is no longer visible in the window 40 thus indicating that the switch 30 is in the open position. When the contact pin 62 stops moving, the insulating compression rod 68 continues to move downward, compressing the insulative plug 66 in the axial direction between the plate 70 and the pin 62 and causing it to expand radially. The compressible insulative plug 66 continues to expand in the radial direction until it is compressed against the interface 82 in the lower housing 34 thereby creating electrical isolation between the male contact pin 62 and the upper female contact 52. This also allows the chamber 42 to be filled with a suitable gas, such as air, and still provide enough dielectric integrity to prevent arcing between the contact pin 62 and the upper female contact 52 over a minimal gap therebetween. A compliance mechanism (not shown) is located between the insulating rod 64 and the actuator and ensures that the plug 66 is compressed with a pre-determined constant force.

When the switch 30 is in the open position the male contact pin 62 is resting on the stop ring 76, the insulative plug 66 is compressed between the plate 70 and the pin 62, and the contact pin 62 is not visible in the window 40. When the switch 30 is closed, the insulating compression rod 64 translates up independently of the pin 62 for the length of the compression gap 84. This decompresses the plug 66 and allows it to return to its uncompressed state. The upper face of the insulating drive rod 64 engages the bottom of the male contact pin 62 causing it to move up. The assembly 60 continues to move upward until the male contact pin 62 and upper female contact 52 are electrically connected. The pin 62 is now visible in the window 40 indicating that the switch 30 is in the closed position.

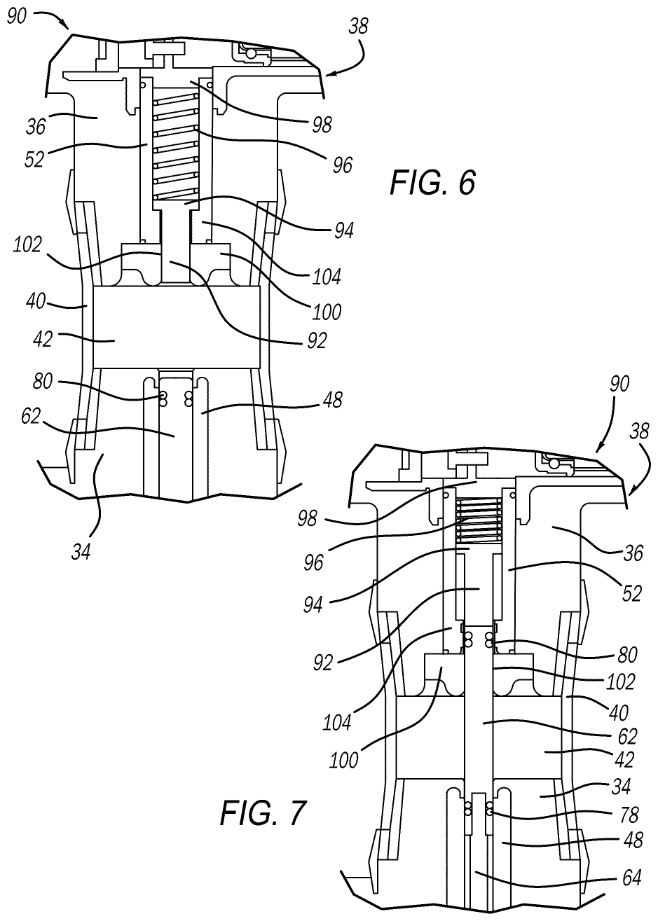

FIGS. 6 and 7 are cut-away, cross-sectional type views of a switch 90 that can be used in the switchgear 10, where the switch 90 is shown in the open position in FIG. 6 and in the closed position in FIG. 7, and where like elements to the switch 30 are identified by the same reference number. In this embodiment, the compressible insulative plug 66, the insulating compression rod 68 and the stop ring 76 are removed. Alternately, a cylindrical rigid insulative plug 92 having a top plate 94 and a slightly larger diameter than the pin 62 is positioned on top of and engages the contact pin 62, a return spring 96 is positioned between the top plate 94 of the plug 92 and a stop member 98 and an annular compressible insulative diaphragm 100 is provided on top of the chamber 42, where the pin 62 extends through a central bore 102 in the diaphragm 100. When the switch 90 is moved from the closed position to the open position, the drive rod 64 is pulled downward to translate the pin 62 downward so that the pin 62 disengages the upper female contact 52 and is pulled into the lower housing 34. The spring 96 pushes the plug 92 into the diaphragm 100 until the top plate 94 engages a flange 104 in the upper female contact 52. The rod 64 continues to pull the pin 62 downward so that is disengages from the plug 92 and is no longer visible in the window 40 indicating that the switch 90 is open.

When the switch 90 is in the closed position the male contact pin 62 contacts the upper and lower female contacts 52 and 48, and the rigid insulative plug 92 is pressed inside the upper female contact 52 by the male contact pin 62. When the switch 90 is opened, the insulating drive rod 64 and the male contact pin 62 translate downward allowing the plug 92 to slide inside the diaphragm 100 under the force of the return spring. The plug 92 reaches its final position when the top plate 94 contacts the flange 104 on the inside of the upper female contact 52. The return spring preload applied to the plug 92 ensures that it will remain in that position. The outside diameter of the plug 92 is larger than the diameter of the bore 102, which creates an interference fit thereby creating electrical isolation between the male contact pin 62 and the upper female contact 52. After the plug 92 reaches its final position, the male contact pin 62 continues its downward translation until it is completely positioned within the lower housing 34.

When the switch 90 is in the open position, the rigid insulative plug 92 is inserted inside the compressible insulative diaphragm 100. When the switch 90 is closed, the male contact pin 62 translates up contacting the bottom end of the plug 92. The male contact pin 62 continues to translate up while pushing the plug 92 out of the diaphragm 100 and into the upper female contact 52 against the bias of the spring 96. The upward motion of the male contact pin 62 and the plug 92 stops at a predetermined position where the male contact pin 62 and the upper and lower contacts 52 and 48 are connected electrically. It is important to note that the section of the male contact pin 62 that contacts the diaphragm 100 in the closed position has a reduced diameter to prevent the diaphragm 100 from stretching.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A switch comprising:
a first housing including a first contact;
a second housing including a second contact and an interface;
a contact pin including a first end and a second end, the contact pin being slidable between and within the first and second housings, and making electrical contact with the first and second contacts when the switch is in a closed position and disengaging the first contact when the switch is in an open position;
an insulative rod extending through the contact pin and protruding from both of the first and second ends of the contact pin, the insulative rod including a plate coupled to an end of the insulative rod extending from the first end of the contact pin;
a drive rod rigidly secured to an end of the insulative rod extending from the second end of the contact pin; and
an insulative plug positioned between the first end of the contact pin and the plate, the insulative rod extending through the plug, wherein the drive rod is actuated to pull the insulative rod so that the contact pin disengages the first contact and the contact pin is pulled into the second housing which causes the insulative plug to axially compress between the plate and the first end of the contact pin and radially expand into the interface.

2. The switch according to claim 1 further comprising an open chamber between the first and second housings and a viewing window surrounding the chamber and being coupled to the first and second housings, the contact pin being positioned in the chamber and being visible through the window when the switch is in the closed positioned and being positioned within the second housing and not visible through the window when the switch is in the open position.

3. The switch according to claim 2 wherein the chamber is filled with an insulative gas.

4. The switch according to claim 3 wherein the gas is air.

5. The switch according to claim 1 further comprising a stop ring positioned within the second housing, the drive rod extending through the stop ring, wherein the compression rod is pulled through the stop ring and the second end of the contact pin engages the stop ring when the switch is put in the open position which causes the drive rod to separate from the second end of the contact pin and the insulative plug to axially compress between the plate and the first end of the contact pin.

6. The switch according to claim 1 wherein the contact pin is a cylindrical pin, the insulative plug is a cylindrical plug and the first and second contacts are female contacts.

7. The switch according to claim 6 wherein an interference fit is provided between an inner diameter of the insulative plug and an outer diameter of the compression rod to create a solid dielectric joint therebetween.

8. The switch according to claim 1 wherein the switch is an isolating pole unit employed in switchgear.

9. A switch comprising:
a first housing including a housing stop member and a first contact having a contact stop member;
a second housing including a second contact;
a contact pin including a first end and a second end, the contact pin being slidable between and within the first and second housings, and making electrical contact with the first and second contacts when the switch is in a closed position and disengaging the first contact when the switch is in an open position;
a rigid insulative plug including a top plate and being in contact with the first end of the contact pin when the switch is in the closed position;
a return spring positioned between the housing stop member and the top plate of the plug, the return spring being under compression when the switch is in the closed position;
a flexible diaphragm positioned within the first housing and including a central bore, the contact pin extending through the central bore when the switch is in the closed position; and
a drive rod rigidly secured to the second end of the contact pin, wherein the drive rod is actuated to pull the drive rod so that the contact pin disengages the first contact and the contact pin is pulled into the second housing which causes the return spring to drive the insulative plug into the bore in the diaphragm and causes the top plate to contact the contact stop member.

10. The switch according to claim 9 further comprising an open chamber between the first and second housings and a viewing window surrounding the chamber and being coupled to the first and second housings, the contact pin being positioned in the chamber and being visible through the window when the switch is in the closed positioned and being positioned within the second housing and not visible through the window when the switch is in the open position.

11. The switch according to claim 10 wherein the chamber is filled with an insulative gas.

12. The switch according to claim 11 wherein the gas is air.

13. The switch according to claim 9 wherein the contact pin is a cylindrical pin, the diaphragm is an annular diaphragm, the insulative plug is a cylindrical plug and the first and second contacts are female contacts.

14. The switch according to claim 13 wherein an outer diameter of the plug is larger than a diameter of the bore so as to create an interference fit therebetween and creating electrical isolation between the contact pin and the first female upper contact.

15. The switch according to claim 9 wherein the switch is an isolating pole unit employed in switchgear.

16. A switch comprising:
a first housing including a first female contact;
a second housing including a second female contact;
a cylindrical contact pin including a first end and a second end, the contact pin being slidable between and within the first and second housings, and making electrical contact with the first and second contacts when the switch is in a closed position and disengaging the first contact when the switch is in an open position;
an open chamber between the first and second housings and a viewing window surrounding the chamber and being coupled to the first and second housings, the contact pin being positioned in the chamber and being visible through the window when the switch is in the closed positioned and being positioned within the second housing and not visible through the window when the switch is in the open position;
an insulative plug coupled to the first end of the contact pin and being configured to provide electrical isolation between the contact pin and the first female contact when the switch is in the open position; and
a drive rod coupled to the contact pin and being actuated to open and close the switch

17. The switch according to claim 16 further comprising an insulative rod extending through the insulative plug and the contact pin and protruding from both of the first and second ends of the contact pin, the insulative rod including a plate coupled to an end of the insulative rod extending from the first end of the contact pin, wherein the plug is a compressible plug and is positioned between the first end of the contact pin and the plate and the first housing includes an interface, and wherein the drive rod is actuated to pull the insulative rod so that the contact pin disengages the first contact and the contact pin is pulled into the second housing which causes the insulative plug to axially compress between the plate and the first end of the contact pin and radially expand into the interface.

18. The switch according to claim 17 further comprising a stop ring positioned within the second housing, the drive rod extending through the stop ring, wherein the compression rod is pulled through the stop ring and the second end of the contact pin engages the stop ring when the switch is put in the open position which causes the drive rod to separate from the second end of the contact pin and the insulative plug to axially compress between the plate and the first end of the contact pin.

19. The switch according to claim 16 wherein the insulative plug is a rigid plug and includes a top plate and is in contact with the first end of the contact pin when the switch is in the closed position, the first housing includes a housing stop member, the first contact includes a contact stop member and the drive rod is rigidly secured to the second end of the contact pin, the switch further comprising a return spring positioned between the housing stop member and the top plate of the plug, and a flexible diaphragm positioned within the first housing and including a central bore, the return spring being under compression and the contact pin extending through the central bore when the switch is in the closed position, wherein the drive rod is actuated to pull the drive rod so that the contact pin disengages the first contact and the contact pin is pulled into the second housing which causes the return spring to drive the insulative plug into the bore in the diaphragm and causes the top plate to contact the contact stop member.

20. The switch according to claim 16 wherein the chamber is filled with an insulative gas.
